(19) United States
(12) Patent Application Publication
(10) Pub. No.: US 2006/0044493 A1
(43) Pub. Date: Mar. 2, 2006

(54) Highly readable display for widely varying lighting conditions

(75) Inventors: David S. Fredley, Coral Springs, FL (US); Habib Amirzadeh, Weston, FL (US); Bharat N. Vakil, Coral Springs, FL (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: MOTOROLA, INC., SCHAUMBURG, IL (US)

(21) Appl. No.: 10/930,581

(22) Filed: Aug. 31, 2004

(51) Int. Cl. G02F 1/1335

(52) U.S. Cl. 349/114

(57) ABSTRACT

A highly readable LCD display (300) with sub-pixels (100) that each has two portions, a tinted portion (116, 120, 124) that is at least partially transmissive and is covered by a color filter (108, 110, 112) in order to color that sub-pixel (100). Sub-pixels (100) further include an un-tinted portion (118, 122, 128) that is at least partially reflective and is not covered by a color filter. The absence of a color filter for the un-tinted at least partially reflective portion of the LCD cell results in greater contrast and reflective brightness for that portion of the cell. The tinted and un-tinted portions are part of the same LCD cell (102, 104, 106) and darken along with the tinted portion of the respective sub-pixel. Three sub-pixels (102, 104, 106) are used to form a three-color pixel (100), a number of which are arranged in a rectangular display array (300).

### FIELD OF THE INVENTION

The present invention generally relates to the field of electronic displays, and more particularly relates to electronic displays that operate in various ambient lighting conditions.

### BACKGROUND OF THE INVENTION

Liquid Crystal Displays (LCDs) are common user interface display devices that are incorporated into a variety of electronic devices. LCDs typically have a number of cells, which can be small pixels or larger display elements, that can be individually darkened to vary the amount of light that is carried through the cell. LCDs operate in one or both of two modes—reflective and transmissive. Transmissive displays operate by having a backlight that shines through the LCD cell. Reflective displays have a reflective layer that allows light to enter the front or viewable side of the display cell that is not darkened, be reflected off of the reflective layer and exit back out of the front of the display. Some LCDs, referred to as transflective LCDs, operate in both a reflective and transmissive mode with simultaneous backlight and reflected incident light. Transflective LCDs allow a display to be used in either a dark or brightly lit environment without changing modes or displays.

Color LCDs operate by having sub-pixels for each cell that correspond to primary colors, such as Red, Green and Blue. Each color sub-pixel has a color filter to give that sub-pixel the desired color. These color filters absorb a significant amount of light and therefore require increased ambient light to operate in a reflective mode. Current color transmissive LCDs also tend to wash out in direct sunlight due to color filters which are used. It's unfortunate that the color LCDs are difficult to read in outdoor environments with a high level of ambient light.

Therefore a need exists to overcome the problems with the prior art as discussed above.

### SUMMARY OF THE INVENTION

Briefly, in accordance with the present invention, a Liquid Crystal Display has at least one sub-pixel. Each sub-pixel has at least one un-tinted liquid crystal cell portion that is at least partially reflective and that reflects incident light without color filtering and at least one tinted liquid crystal cell portion that is at least partially transmissive and that emits light with color filtering.

The present invention also concerns a method for displaying at least one pixel. The method includes providing at least one sub-pixel. The method includes providing at least one sub-pixel includes providing at least one un-tinted reflective liquid crystal cell portion that reflects incident light without color filtering and providing at least one tinted transmissive liquid crystal cell portion that emits light with color filtering.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a highly readable LCD display pixel according to an exemplary embodiment of the present invention.

FIG. 2 illustrates a portion of a column of exemplary pixels, in accordance with an exemplary embodiment of the present invention.

FIG. 3 illustrates a portion of a highly readable display in accordance with an exemplary embodiment of the present invention.

FIG. 4 illustrates a display processing flow diagram according to an exemplary embodiment of the present invention.

FIG. 5 illustrates a top level display fabrication flow for fabricating a display according to an exemplary embodiment of the present invention.

FIG. 6 illustrates a cellular phone block diagram according to an exemplary embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

The present invention, according to a embodiment, advantageously overcomes problems with the prior art by providing an apparatus and method for providing a display that is both highly readable under outdoor lighting conditions and is highly readable and displays color under indoor lighting conditions, as will be discussed in detail below. Displays according to the present invention are particularly advantageous, for example, when included in cellular telephones that are frequently used outdoors during daylight, such as for work related purposes by individuals in construction, when readability is more important and that are also used indoors for personal uses when a color display is more highly desired.

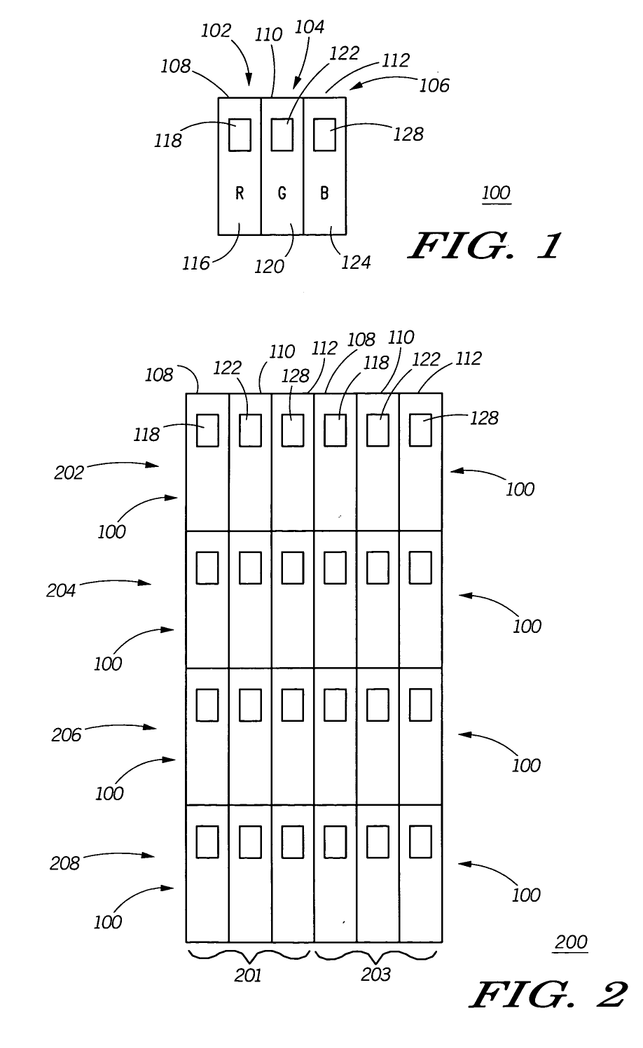

FIG. 1 illustrates a highly readable LCD display pixel 100 according to an exemplary embodiment of the present invention. Exemplary pixel 100 is a single pixel that is part of a rectangular array of pixels that form a two dimensional display, such as is incorporated into a wide variety of electronic devices. Exemplary pixel 100 is shown to consist of three sub-pixels, a red sub-pixel 102, a green sub-pixel 104 and a blue sub-pixel 106. Exemplary pixel 100 is shown to have three color filter strips, a red color filter strip 108, a green color filter strip 110 and a blue color filter strip 112, that are each associated with a respective sub-pixel. Each color filter strip in the exemplary embodiment extends vertically across all of the pixels that are in a particular column of the rectangular array of pixels with which the color filter strip is associated, with the exception of areas of the filter in reflective portions that are removed, as is described below.

Each sub-pixel of the exemplary pixel 100 has two sections. Each sub-pixel is identified herein by a color that is associated with that sub-pixel. Each sub-pixel includes a tinted portion that is covered by a color filter in order to give a particular color to that sub-pixel and to cause that sub-pixel to emit light with color filtering. In the exemplary embodiment, the tinted portion is a transmissive portion of the sub-pixel and is illuminated by a backlight behind the display (not shown). Each sub-pixel further includes an un-tinted portion that does not have a color filter, but in the exemplary embodiment is a part of the same LCD cell as the tinted portion and darkens along with the tinted portion of the respective sub-pixel. Both portions of this exemplary sub-pixel are controlled by a single control signal, which is an electrical control signal that controls the amount that the sub-pixel is darkened. The un-tinted portion of each sub-pixel in the exemplary embodiment is a reflective LCD cell and operates to reflect ambient light. The lack of a color filter over the un-tinted portion of each sub-pixel causes the un-tinted portion of each sub-pixel to reflect incident light without color filtering. This advantageously allows a single LCD cell to act as an un-tinted reflective cell and a transmissive tinted cell, thereby allowing a single pixel drive circuit to activate both portions and allow increased pixel density.

Although a portion of each of the exemplary sub-pixels is un-tinted, and therefore exhibits no color when displayed, the following description identifies the un-tinted portion of each sub-pixel with a reference to the color of the tinted portion that is a part of the same LCD cell. For example, the red sub-pixel 102 has a red tinted transmissive portion 116 and an un-tinted, red reflective portion 118. The green sub-pixel 104 similarly has a green tinted transmissive portion 120 and an un-tinted green reflective portion 122 and the blue sub-pixel 106 has a blue tinted transmissive portion 124 and an un-tinted blue reflective portion 128. These un-tinted portions do not exhibit a particular color when un-darkened, but reflect monochrome light and therefore make up a monochrome LCD cell when operating as a predominately reflective cell in bright ambient light conditions.

The exemplary embodiment of the present invention uses tinted LCD cell portions that are transmissive and un-tinted LCD cell portions that are reflective. Further embodiments of the present invention utilize at least partially transmissive and/or at least partially reflective LCD cell portions for one or both of these cell portions.

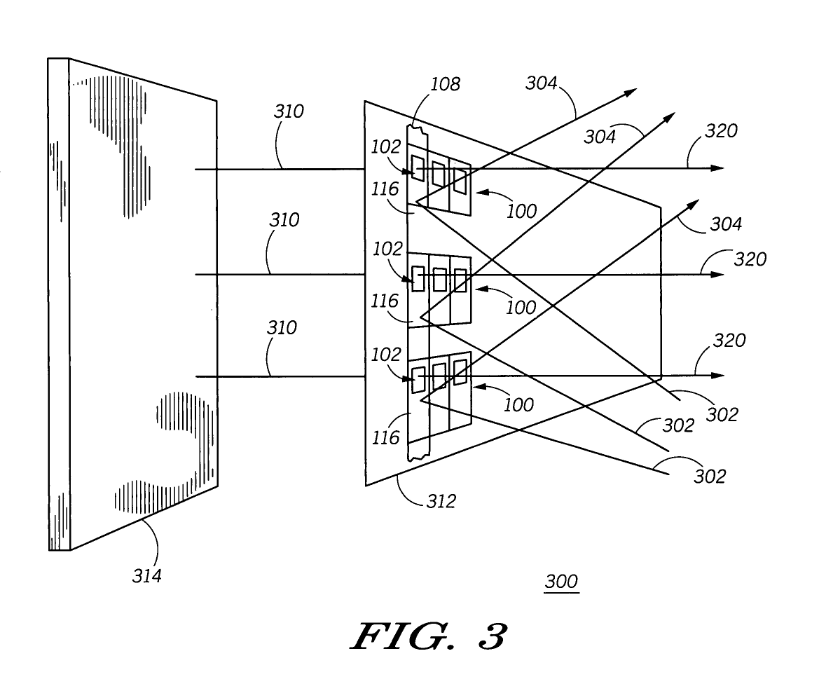

FIG. 2 illustrates a display portion 200 of exemplary pixels 100, in accordance with an exemplary embodiment of the present invention. Display portion 200 illustrates a column 201 that is one of multiple columns of pixels that form a display that contains a rectangular array of exemplary pixels 100. An adjacent column 203 is also shown. The illustrated portion of column 201 shows four exemplary pixels, a first pixel 202, a second pixel 204, a third pixel 206 and a fourth pixel 208. A display containing a rectangular array of exemplary pixels will contain many rows and many columns of exemplary pixels 100 to create an array of pixels suitable for the particular requirements of that display. The portion of column 201 illustrates that the color filter bands, which include a red color filter band 108, a green color filter band 110 and a blue color filter band 112, extend over a portion of each of their respective sub-pixels in that column. Other columns of the rectangular array have separate color filter bands that extend over their respective sub-pixels.

The portion of column 201 also illustrates that each sub-pixel has an un-tinted portion. The un-tinted portions, including the un-tinted, red reflective portion 118, the un-tinted green reflective portion 122, and the un-tinted blue reflective portion 128, are reflective mode portions of each sub-pixel, as is discussed above. The un-tinted portions reflect ambient light and exhibit a monochrome display appearance. The absence of color filters over the un-tinted portions results in greater light reflection than would be present if there were color filters over those portions of the sub-pixels. This results in improved visibility and increased contrast in bright ambient light conditions while allowing the display to effectively operate in a transmissive mode with a backlight under low ambient light conditions. This is a significant advantage of the present invention.

FIG. 3 illustrates a portion of a highly readable display 300 in accordance with an exemplary embodiment of the present invention. The highly readable display 300 according to the exemplary embodiment contains a large number of pixels arranged in a rectangular array. These pixels are uniformly arranged with a constant pitch, which is a distance between each pixel, across the display. In order to simplify the illustration and description of this exemplary embodiment of the present invention, this illustration shows one sub-pixel for each of only four pixels in the display. It is to be understood that each pixel in this exemplary display contains three sub-pixels, one for each primary color as shown for the exemplary pixel 100, above. It is further to be understood that this exemplary display contains a uniform, rectangular array of many, closely arranged, pixels.

The exemplary display 300 shows a liquid crystal panel 312 that contains a rectangular array of color pixels. Each pixel in the liquid crystal panel 312 is similar to the exemplary pixel 100, described above, and has three sub-pixels that each have a tinted transmissive and an un-tinted reflective portion. This illustration shows one sub-pixel, a red sub-pixel 102, for each of three illustrated pixels 100 of the exemplary display 300. These sub-pixels 102 are shown to be in the same column and have a common red color filter band 108. As discussed above, the other sub-pixels of this column, and sub-pixels of other columns, have other color filter bands as is also described above. In the following description, the three illustrated sub-pixels are shown to be un-darkened, that is that they are configured to transmit and/or reflect light.

The exemplary display 300 includes a backlight 314. Backlight 314 provides a uniform illumination across the back of the liquid crystal panel 312. Backlighting can be supplied in many different ways, as is known to those of ordinary skill in the art. For example, backlight can be supplied by any one or more of the following: an electroluminescent (EL) panel, at least one lamp, at least one light emitting diode (LED), cold cathode florescence (CCF), and any backlighting source combined with a light pipe and/or with a light diffuser to more evenly distribute backlight to the LCD panel 312. Internal light rays 310 from backlight 314 are shown to pass through the transmissive red tinted portion 116 of the red sub-pixel 102. These internal light rays 310 are filtered to a red color and are emitted through the front of the liquid crystal panel 312 as a red filtered light ray 320. Each sub-pixel is able to be selectively, and individually, darkened in varying degree to reduce or stop this red light from being transmitted through the sub-pixel and out the front of the liquid crystal panel 312.

Ambient light rays 302 are also shown to impinge upon the surface of the liquid crystal panel 312. These light rays are able to originate from indoor room lighting as well as outdoor sunlight depending upon the location of and lighting conditions around the exemplary display 300. The ambient light rays 302 are further able to originate from any angle relative to the front of the liquid crystal panel 312. The ambient light rays 302 are reflected by the non-tinted reflective portion of the sub-pixels 102 and each sub-pixel produces a reflected ray 304. The reflective nature of the non-tinted reflective portion in the exemplary embodiment prevents light from the backlight 314 from being emitted through the un-tinted, reflective portion of each sub-pixel. Similarly, the transmissive portion of each sub-pixel 102 does not reflect ambient light and only emits light originating from backlight 314. Further embodiments of the present invention incorporate partially reflective portions within the sub-pixels so that ambient light and light from backlight 314 are emitted by the sub-pixels.

Because the reflective portions of the sub-pixels are non-tinted, monochrome light is reflected as the reflected rays 304. The reflected light in this discussion is referred to as monochrome because it is unfiltered as to color. It is clear, however, that the reflected light will typically have the spectral components of the incident ambient light rays 302. In any case, the exemplary embodiment of the present invention attenuates the ambient light rays 302 to a much lesser degree when producing reflected rays 304 due to this absence of color filters. Color filters have been observed to attenuate ambient light rays by up to approximately sixty seven percent (67%). The operation of the exemplary display obviates this attenuation by not using color filters for reflective portions of sub-pixels.

This illustration shows that both reflected light rays 304 and internal light rays 310 are able to be simultaneously produced by the exemplary display 300. In the absence of significant ambient light rays 302, such as in an indoor environment, the internal light rays 310 will be the predominant light output of the exemplary display 300 by being emitted through the transmissive portions of each sub-pixel 102. Since the internally generated light rays 310 are color filtered by the transmissive portions of the sub-pixels, this light output will exhibit the three colors that are produced by the tinted transmissive portions of the sub-pixels. In the presence of significant ambient light, however, the reflected light rays 304 will be the predominant light output. Since the reflective light is not attenuated by color filters, these sub-pixels exhibit greater contrast compared to conventional pixels that color filter reflective light.

It is to be further noted that further embodiments of the present invention place a color filter (not shown) or other transparent or translucent design (not shown) over part or all of the display 300 to achieve a desired aesthetic effect. Although such filters or designs may absorb incident light, these further embodiments operate adequately to achieve a benefit over conventional displays. In the presence of such filters, transmissive liquid crystal cell portions that emit light without color filtering are intended to include such liquid crystal cells that do not have a color filter associated with the cell itself, even though there may be a larger color filter that covers a portion of the entire display.

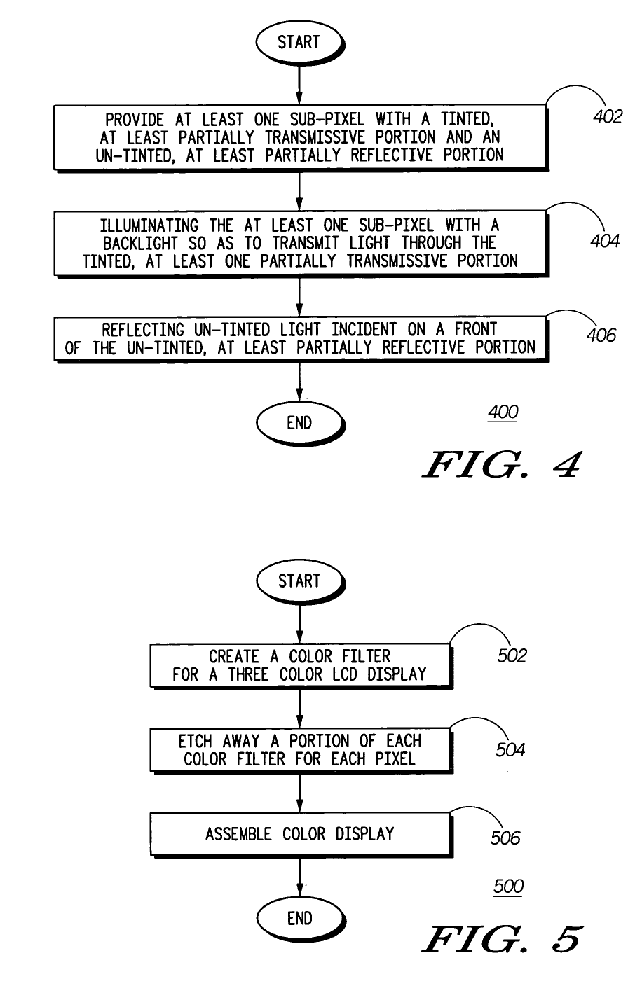

FIG. 4 illustrates a display processing flow diagram 400 according to an exemplary embodiment of the present invention. The display processing begins by providing, at step 402, at least one sub-pixel with a tinted portion that is at least partially transmissive and an un-tinted portion that is at least partially reflective. The processing continues by illuminating, at step 404, the at least one sub-pixel with a backlight. The processing also reflects, at step 406, un-tinted light that is incident on a front of the at least one sub-pixel. The processing then ends.

Different embodiments of the present invention are able to be fabricated in a variety of ways. In the exemplary embodiment, color filter bands, such as red filter band 108, green filter band 110, and blue filter band 112, extend along a column of pixels in the display. Further embodiments are able to use any type of suitable color filter, such as color filters that are fitted to each sub-pixel or that form various patterns across the front of the display. Yet further embodiments are able to have a single color filter across entire pixels to create a filtered monochrome display for the display when operating in a reflective mode.

Each of the sub-pixels of the exemplary embodiment has a portion that is covered by a color filter and another portion that is not covered by a color filter. In the exemplary pixel 100 illustrated above, the un-tinted, red reflective portion 118, for example, has a size equal to red tinted transmissive portion 116. In further embodiments, other relative sizes for the un-tinted, reflective portions and the tinted transmissive portions are used. Having a portion of each sub-pixel allocated as a reflective, un-tinted portion that is larger than the tinted transmissive portion enhances the performance of such displays in high ambient light. For example, another embodiment provides the equivalent of the un-tinted, red reflective portion 118 at twice the size of the red tinted transmissive portion 116 to increase the contrast of that display in bright ambient light conditions. Further embodiments have un-tinted portions that are smaller than the tinted portion of each sub-pixel. Other variations of the above discussed alternatives should be obvious to those of ordinary skill in the art in view of the present discussion. For example, the overall size ratios between the tinted transmissive portion and the un-tinted reflective portion of pixels can be varied for different desired effects.

Various methods can be used to construct such a color filter for the LCD pixels. A color filter is able to be fabricated by placing color filter bands on a substrate with the dimensions required by the finished display. The exemplary embodiment forms the color filter by creating a conventional color filter that has color filter bands that extend over the entire sub-pixel and then etching away part of the color filter bands to cause un-tinted pixel portions to be created for each sub-pixel.

FIG. 5 illustrates a top level display fabrication flow 500 for fabricating a display according to an exemplary embodiment of the present invention. The top level display fabrication flow 500 begins by creating, at step 502, a conventional color filter for a three color LCD display. The processing then etches away, at step 504, a portion of each color filter for each pixel. This etching is performed so as to cause un-tinted portions of each sub-element to be present in the finished display. The processing then assembles, at step 506, the finished color display.

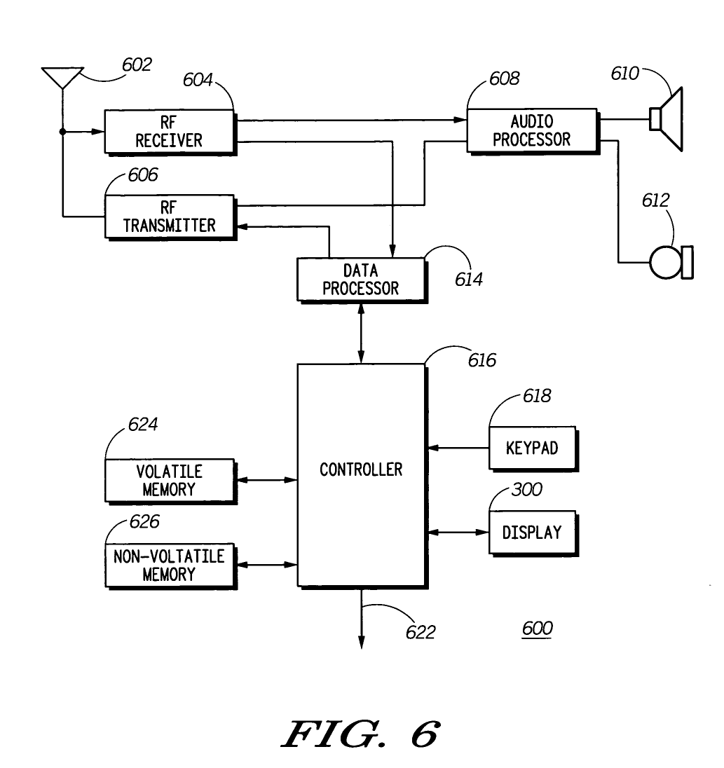

FIG. 6 illustrates a cellular phone block diagram 600 according to an exemplary embodiment of the present invention. The cellular phone block diagram 600 describes a cellular phone that is a device including an embodiment of the present invention. The cellular phone block diagram 600 includes an RF antenna 602, a receiver 604 and an RF transmitter 606. The RF transmitter 606 and RF receiver 604 are connected to the RF antenna 602 in order to support bi-directional RF communications. The cellular phone 600 is able to simultaneously transmit and receive voice and/or data signals. The RF receiver 604 provides voice data to an audio processor 608 and the audio processor 608 provides voice data to the RF transmitter 606 to implement voice communications. The audio processor 608 obtains voice signals from microphone 610 and provides voice signals to a speaker 610. The RF receiver 604, RF transmitter 606, audio processor 608, microphone 610, and speaker 610, operate to communicate voice signals to and from the cellular phone 600, in a manner that is well known to those of ordinary skill in the art.

The cellular phone block diagram 600 includes a controller 616 that controls the operation of the cellular phone in the exemplary embodiment. Controller 616 is connected to the various components of the cellular phone block diagram 600 via control bus 622. Controller 616 communicates data to external devices, such as a base station and/or server (not shown), through a wireless link. Controller 616 provides data to and accepts data from data processor 614. Data processor 614 of the exemplary embodiment performs communications processing necessary to implement over-the-air data communications to and from external stations. Data processor 614 provides data for transmission to the RF transmitter 606 and accepts received data from RF receiver 604.

Controller 616 provides visual display data to the user through user display 300. Display 300 of the exemplary embodiment comprises a highly readable Liquid Crystal Display that operates as described herein. Controller 614 also accepts user input from keypad 618. Keypad 618 is similar to a conventional cellular phone keypad and has buttons to accept user input in order to support operation of the exemplary embodiment of the present invention.

The cellular phone block diagram 600 further includes non-volatile memory 626. Non-volatile memory 626 stores program data and more persistent data for use by controller 616. Data stored in non-volatile memory 626 of the exemplary embodiment can be changed under control of controller 616 if called for by particular processing performed by the controller 616. The cellular phone block diagram 600 further contains volatile memory 624. Volatile memory 624 is able to store transient data for use by processing and/or calculations performed by controller 616.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

What is claimed is:

1. A liquid crystal display, comprising:
at least one sub-pixel comprising:
at least one un-tinted liquid crystal cell portion that is at least partially reflective and that reflects incident light without color filtering; and
at least one tinted liquid crystal cell portion that is at least partially transmissive and that emits light with color filtering.

2. The liquid crystal display according to claim 1, wherein the at least one un-tinted liquid crystal cell portion and the at least one tinted liquid crystal cell portion of a particular sub-pixel within the at least one sub-pixel are controlled by a single control signal.

3. The liquid crystal display according to claim 1, wherein the at least one un-tinted liquid crystal cell portion is fabricated by etching away at least part of a color filter.

4. The liquid crystal display according to claim 1, wherein the at least one un-tinted liquid crystal cell portion is larger than the at least one tinted liquid crystal cell portion.

5. The liquid crystal display according to claim 1, wherein the at least one un-tinted liquid crystal cell portion is smaller than the at least one tinted liquid crystal cell portion.

6. The liquid crystal display according to claim 1, comprising at least one display pixel, each of the at least one display pixel comprising three of the at least one sub-pixel, the respective tinted liquid crystal cell portions of the three of the at least one sub-pixel comprising at least one of the following:
at least one liquid crystal cell that has an at least partially transmissive portion that has a blue color filter;
at least one liquid crystal cell that has an at least partially transmissive portion that has a red color filter; and
at least one liquid crystal cell that has an at least partially transmissive portion that has a green color filter;

7. A method for displaying at least one pixel, the method comprising providing at least one sub-pixel, wherein the providing comprises:
providing at least one un-tinted reflective liquid crystal cell portion that reflects incident light without color filtering; and
providing at least one tinted transmissive liquid crystal cell portion that emits light with color filtering.

8. The method according to claim 7, further comprising controlling the at least one un-tinted reflective liquid crystal cell portion and the at least one tinted transmissive liquid crystal cell portion of a particular sub-pixel within the at least one sub-pixel by a single control signal.

9. The method according to claim 7, wherein the providing at least one un-tinted reflective liquid crystal cell portion comprises etching away at least part of a color filter.

10. The method according to claim 7, providing the at least one un-tinted reflective liquid crystal cell portion comprises providing the at least one un-tinted reflective liquid crystal cell portion that is larger than the at least one tinted transmissive liquid crystal cell portion.

11. The method according to claim 7, providing the at least one un-tinted reflective liquid crystal cell portion comprises providing the at least one un-tinted liquid crystal cell portion that is smaller than the at least one tinted liquid crystal cell portion.

12. The method according to claim 7, further comprising providing a liquid crystal display with at least one display pixel, each of the at least one display pixel comprising three of the at least one provided sub-pixel, and wherein the providing the respective tinted liquid crystal cell portion of the three of the at least one sub-pixel comprises at least one of the following:
providing at least one tinted transmissive liquid crystal cell portion that has a blue color filter;
providing at least one tinted transmissive liquid crystal cell portion that has a red color filter; and
providing at least one tinted transmissive liquid crystal cell portion that has a green color filter;

13. A method for fabricating a liquid crystal display, the method comprising:
creating a color filter for a three color liquid crystal display;
etching away at least a portion of at least one color filter for each pixel; and
assembling the color liquid crystal display.
